(19) United States
(12) Patent Application Publication
(10) Pub. No.: US 2026/0035610 A1
(43) Pub. Date: Feb. 5, 2026

(54) TEMPERATURE-SENSITIVE FOAMING DRAINAGE AGENT SYSTEM FOR HIGH-TEMPERATURE AND HIGH-SALT GAS RESERVOIRS, PREPARATION METHOD AND APPLICATION THEREOF

(71) Applicants: Southwest Petroleum University, Chengdu (CN); Sichuan Ruidong Technology Co., Ltd, Chengdu (CN)

(72) Inventors: Xuecheng ZHENG, Chengdu (CN); Xiaoliang LIU, Chengdu (CN); Yonghui LIU, Chengdu (CN); Lei TANG, Chengdu (CN); Xiaochen ZHANG, Chengdu (CN); Wei SHI, Chengdu (CN); Yuanqiang ZHU, Chengdu (CN); Shusong ZHANG, Chengdu (CN); Wanwan PENG, Chengdu (CN)

(21) Appl. No.: 18/621,454

(22) Filed: Mar. 29, 2024

(30) Foreign Application Priority Data
Mar. 31, 2023 (CN) 2023103327175

(51) Int. Cl. C09K 8/584

(52) U.S. Cl. CPC C09K 8/584; C09K 2208/08

(57) ABSTRACT

The disclosure relates to the technical field of oilfield chemistry, and in particular to a temperature-sensitive foaming drainage agent system for high-temperature and high-salt gas reservoirs, a preparation method and an application thereof. The temperature-sensitive foaming drainage agent system includes following components in parts by mass: 50-75 parts of foaming agent, 1-3 parts of temperature-sensitive material, 2-5 parts of bactericide and 500-800 parts of water; and the temperature-sensitive material is temperature-sensitive gel.

### TECHNICAL FIELD

The disclosure relates to a technical field of oilfield chemistry, and in particular to a temperature-sensitive foaming drainage agent system for high-temperature and high-salt gas reservoirs, a preparation method and an application thereof.

### BACKGROUND

Bottom hole liquid loading of the gas well mainly comes from fracturing fluid trapped in the formation, but also from frac hit, edge and edge-bottom water invasion and so on, and has characteristics of high salinity, high temperature and high bacterial content. Aiming at bottom hole liquid loading of the gas well, foam drainage gas recovery technology is often used in the field, which has advantages of simple equipment, easy construction, quick effect, low cost and no influence on the normal production of the gas well.

The cost of foam drainage gas recovery process mainly focuses on the cost of chemicals, one is the cost of foam drainage agent, and the other is the cost of defoamer. At present, most commercial foaming drainage agents have poor resistance on temperature, salt and oil, and the preparation of agents with better performance is difficult and generally expensive. With the development of gas field, gas reservoirs under harsh conditions such as high temperature, high salt and condensate oil are in urgent need of a more economical and effective foaming and discharging agent system.

Therefore, it is necessary to develop a temperature-sensitive foaming drainage agent system with low cost, high temperature resistance, salt resistance, oil resistance and sterilization performance, high foaming and stable foaming at high temperature at the bottom of the well, and low foaming and low stable foaming at low temperature at the wellhead, and its preparation method and application, which can not only meet field requirements for foaming agent, but also reduce the defoaming difficulty of ground equipment and the amount of defoaming agent, thus being beneficial to gas field development and large-scale promotion of the foam drainage gas recovery technology.

### SUMMARY

Aiming to overcome shortcomings of the prior art, the disclosure provides a temperature-sensitive foaming drainage agent system for high-temperature and high-salt gas reservoirs, a preparation method and an application thereof. With existing low-cost agents and a natural temperature gradient between the well bottom and the wellhead, a temperature-sensitive foaming drainage agent system for high-temperature and high-salt gas reservoirs has good foaming and foam-stabilizing properties in fracturing flowback fluid, and has characteristics of high foaming and foam-stabilizing under high temperature at the well bottom and low foaming and foam-stabilizing under low temperature at the wellhead.

The disclosure is achieved through a following technical scheme:
The temperature-sensitive foaming drainage agent system for high-temperature and high-salt gas reservoirs includes following components in parts by mass: 50-75 parts of foaming agent, 1-3 parts of temperature-sensitive material, 2-5 parts of bactericide and 500-800 parts of water,
where the temperature-sensitive material is temperature-sensitive gel.

In a specific embodiment of the scheme, the foaming agent includes sulfonate anionic surfactant A, sulfonate anionic surfactant B, and an amine oxide zwitterionic surfactant;

and a mass ratio of sulfonate anionic surfactant A, sulfonate anionic surfactant B and amine oxide zwitterionic surfactant is 2:2:1.

In a specific embodiment of the scheme, the sulfonate anionic surfactant A is sodium dodecyl benzene sulfonate, and the sulfonate anionic surfactant B is sodium α-olefin sulfonate.

Sodium α-olefin sulfonate is an anionic surfactant with high foaming and good hydrolysis stability, and has excellent hard water resistance, low toxicity, gentleness, low irritation and good biodegradability.

In a specific embodiment of the scheme, the amine oxide zwitterionic surfactant is N,N-dimethyldodecylamine-N-oxide.

In a specific embodiment of the scheme, the bactericide is hexadecyl trimethyl ammonium chloride.

Further, a preparation of the temperature-sensitive gel includes following steps:
step 1, firstly weighing 100 parts of cotton fiber by mass, and impregnating cotton fiber with 3500 parts of 40% (mass fraction) sodium hydroxide solution at 30° C. for 1 h;
step 2, squeezing impregnated cotton fiber obtained in the step 1, where a squeezing ratio is 3.0, and then crushing and curing the cotton fiber by a crusher for 4h;
step 3, putting material obtained in the step 2 into a kettle for vacuumizing, then sequentially adding 200 parts of propylene oxide and 900 parts of carbon tetrachloride into the kettle, then heating to 50° C., and keeping the temperature for reaction for 3h;
step 4, reacting material prepared in the step 3 at 80° C. for 2h, then neutralizing, washing, centrifugally dehydrating and drying at 95° C. to prepare a crude product;
step 5, placing the crude product obtained in the step 4 in warm water at 80° C., stirring to dissolve the crude product, and then cooling the crude product to room temperature; and
step 6, heating colloid solution obtained in the step 5 to a colloid dehydration shrinkage temperature; finally, obtaining white powder after centrifugation, drying and crushing, the white powder is the temperature-sensitive gel with a purity of 95% and a gel point of 60-70° C.

Hexadecyl trimethyl ammonium chloride is a cationic surfactant with a molecular formula of C₁₉H₄₂ClN, and has good chemical stability, heat resistance, light resistance, pressure resistance and strong acid and alkali resistance, and has excellent bactericidal performance.

In a specific embodiment of the scheme, water is tap water or clean water from a water source well near the gas well.

On the other hand, the scheme also provides a preparation method for preparing the temperature-sensitive foaming drainage agent system for high-temperature and high-salt gas reservoirs, including following steps:
S1, taking each component according to a formula ratio;
S2, adding the temperature-sensitive material into water and uniformly stirring at normal temperature; and
S3, adding the foaming agent and a bactericide into the solution prepared in the S2, and uniformly stirring to obtain the temperature-sensitive foaming drainage agent system for high-temperature and high-salt gas reservoirs.

On the other hand, the scheme also provides an application of the temperature-sensitive foaming drainage agent system for high-temperature and high-salt gas reservoirs in gas well drainage and gas recovery technology.

Further, in a specific embodiment of the scheme, a dosing concentration of the temperature-sensitive foaming drainage agent system for high-temperature and high-salt gas reservoirs is 5%.

In the disclosure, the selected foaming agent consists of sodium dodecyl benzene sulfonate, sodium α-olefin sulfonate and N,N-dimethyldodecylamine-N-oxide; among them, sodium dodecyl benzene sulfonate and sodium α-olefin sulfonate are both temperature-resistant and salt-resistant foaming agents. Sodium dodecyl benzene sulfonate is low in price, but difficult to dissolve and has a low foaming height, while sodium α-olefin sulfonate is easy to dissolve and has a high foaming height, but its price is slightly higher. However, sodium dodecyl benzene sulfonate and sodium α-olefin sulfonate are compounded in a certain proportion, and under a solubilization effect of long-chain hydrophobic association of sodium α-olefin sulfonate, sodium dodecyl benzene sulfonate is dissolved quickly, and an economical and highly suitable pharmaceutical system is obtained.

In the disclosure, N,N-dimethyldodecylamine-N-oxide is a nonionic foaming agent in neutral or alkaline medium, and has excellent oil resistance, so under the synergistic effect of sodium dodecyl benzene sulfonate, sodium α-olefin sulfonate and N,N-dimethyldodecylamine-N-oxide, the foaming agent system is resistant to temperature, salt and oil, and the foaming performance and economy of the system are in line with the expected requirements.

In the disclosure, a temperature-sensitive gel with a gel point of 60-70° C. is added as a stabilizer in the foaming drainage agent system, and the molecular chain of the temperature-sensitive gel has no basic elements which have complexation effect with dodecyl dimethyl ammonium oxide, sodium α-alkenylsulfonate, sodium dodecyl benzene sulfonate and hexadecyl trimethyl ammonium chloride, so that the temperature-sensitive gel mainly plays a role in adjusting the viscosity of the system in accordance with the change in temperature; when the temperature-sensitive gel is added into the foaming drainage agent system, the viscosity of the system is effectively increased and the foam stability is enhanced at downhole high temperature; and the viscosity is reduced and the foam stability is reduced at downhole low temperature. Therefore, the defoaming difficulty of ground equipment is effectively reduced, and the consumption of defoaming agent is reduced.

The disclosure has following beneficial effects:
(1) In this scheme, the temperature-sensitive gel with the gel point of 60-70° C. is selected as the stabilizer in the foaming drainage agent system, adjusting the viscosity of the system in accordance with the change in temperature; therefore, the temperature-sensitive gel effectively increases the viscosity of the system and enhances the foam stability when the gas well at downhole high temperature, and decreases the viscosity and the foam stability at downhole low temperature, thus effectively reducing the defoaming difficulty of ground equipment and reducing the consumption of defoaming agent;
(2) the foaming agent selected in the disclosure consists of sodium dodecyl benzene sulfonate, sodium α-olefin sulfonate and N,N-dimethyldodecylamine-N-oxide. Under the synergistic effect of sodium dodecyl benzene sulfonate, sodium α-olefin sulfonate and N,N-dimethyldodecylamine-N-oxide, the foaming agent system is resistant to temperature, salt and oil, and the foaming performance and economy of the system are in line with the expected requirements; and
(3) the cationic foaming agent with bactericidal effect is hexadecyl trimethyl ammonium chloride, which has good synergistic effect with sodium dodecyl benzene sulfonate, sodium α-olefin sulfonate and N,N-dimethyldodecylamine-N-oxide, effectively increasing the foaming height.

### BRIEF DESCRIPTION OF THE DRAWINGS

FIG. 1 is a test chart of foaming performance of a foaming drainage agent.

FIG. 2 is a test chart of storage modulus of the foaming drainage agent.

FIG. 3 is a test chart of loss modulus of the foaming drainage agent.

FIG. 4 is an observation diagram of a coarsening behavior of the foaming drainage agent at 50° C.

FIG. 5 is an observation diagram of a coarsening behavior of the foaming drainage agent at 90° C.

FIG. 6 is a test chart of foaming performance of a test group Z and a test group N.

### DETAILED DESCRIPTION OF THE EMBODIMENTS

The technical scheme of the present disclosure is further described in detail with specific embodiments, but the protection scope of the present disclosure is not limited to the following.

In embodiments of the scheme, a preparation of the temperature-sensitive gel includes following steps:
step 1, firstly weighing 100 parts of cotton fiber by mass, and impregnating cotton fiber with 3500 parts of 40% (mass fraction) sodium hydroxide solution at 30° C. for 1 h;
step 2, squeezing impregnated cotton fiber obtained in the step 1, where a squeezing ratio is 3.0, and then crushing and curing the cotton fiber by a crusher for 4h;
step 3, putting material obtained in the above step 2 into a kettle for vacuumizing, then sequentially adding 200 parts of propylene oxide and 900 parts of carbon tetrachloride into the kettle, then heating to 50° C., and keeping the temperature for reaction for 3h;
step 4, reacting material prepared in the above step 3 at 80° C. for 2h, then neutralizing, washing, centrifugally dehydrating and drying at 95° C. to prepare a crude product;
step 5, placing the crude product obtained in the above step 4 in warm water at 80° C., stirring to dissolve the crude product, and then cooling the crude product to room temperature; and
step 6, heating colloid solution obtained in the above step 5 to a colloid dehydration shrinkage temperature; finally, obtaining white powder after centrifugation, drying and crushing, the white powder is the temperature-sensitive gel with a purity of 95% and a gel point of 60-70°C.

The foaming agents used in the embodiment of the disclosure are all commercially available products, and the purity level of the products is industrial pure.

### Embodiment 1

a temperature-sensitive foaming drainage agent system for high-temperature and high-salt gas reservoirs consists of following components in parts by mass: 30 parts of sodium dodecyl benzene sulfonate, 30 parts of sodium α-olefin sulfonate, 15 parts of N,N-dimethyldodecylamine-N-oxide, 3 parts of temperature-sensitive gel, 5 parts of hexadecyl trimethyl ammonium chloride and 700 parts of water.

### Embodiment 2

a temperature-sensitive foaming drainage agent system for high-temperature and high-salt gas reservoirs consists of following components in parts by mass: 20 parts of sodium dodecyl benzene sulfonate, 20 parts of sodium α-olefin sulfonate, 10 parts of N,N-dimethyldodecylamine-N-oxide, 1 part of temperature-sensitive gel, 2 parts of hexadecyl trimethyl ammonium chloride and 500 parts of water.

### Preparation Method

taking components in proportion, adding temperature-sensitive material into water at room temperature, evenly stirring the temperature-sensitive material, then adding the foaming agent and bactericide, evenly stirring again, and obtaining the temperature-sensitive foaming drainage agent system for high-temperature and high-salt gas reservoirs.

### Embodiment 3

A temperature-sensitive foaming drainage agent system for high-temperature and high-salt gas reservoirs consists of following components in parts by mass: 20 parts of sodium dodecyl benzene sulfonate, 20 parts of sodium α-olefin sulfonate, 10 parts of N,N-dimethyldodecylamine-N-oxide, 2 parts of temperature-sensitive gel, 2 parts of hexadecyl trimethyl ammonium chloride and 500 parts of water.

The preparation method is the same as in Embodiment 2.

### Embodiment 4

diluting the temperature-sensitive foaming drainage agent system for high-temperature and high-salt gas reservoirs prepared in Embodiment 3 by 20 times with the gas well backflow liquid without foaming measures to obtain foaming drainage agent system solution.

### Embodiment 5

testing the foaming drainage agent system solution prepared in Embodiment 4 for indoor foaming height and foam stability height. Tests are carried out with 2151 Roche foam meter.

In this embodiment, two test groups, X and Y, are carried out. The test group Y represents the indoor foaming height and foam stability height test under 50° C., and the test group X represents the indoor foaming height and foam stability height test under 90° C.

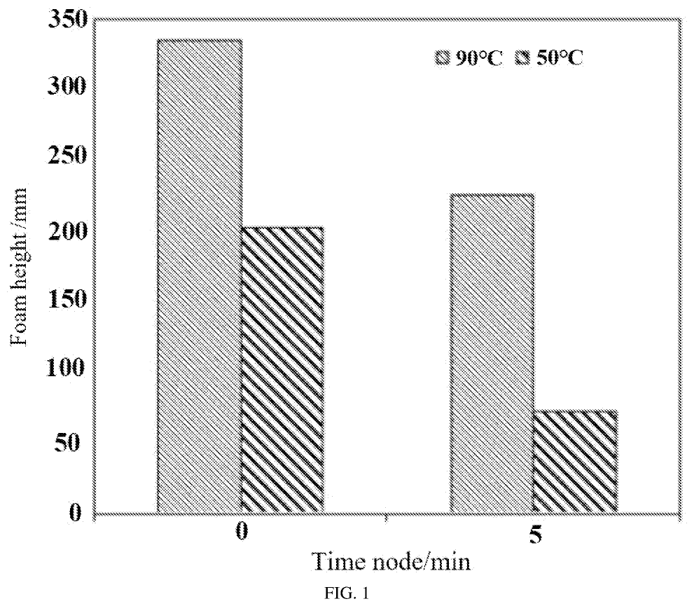

The test results are shown in FIG. 1: at 50° C., the initial foam height is 203 mm, and the foam height is 72 mm after 5 min; at 90° C., the initial foam height is 335 mm, and the foam height is 226 mm after 5 min.

By comparing the test results of the test group X and the test group Y, it may be seen that this scheme further increases the viscosity of the system and enhances the stability of the foam at high temperature (90° C.).

### Embodiment 6

when the foaming drainage agent system prepared in Embodiment 3 is applied to the foam drainage gas recovery process of the gas well, the daily dosage is calculated by multiplying the daily liquid production of the gas well by 5%.

### Comparative Example

In this comparative example, the foaming drainage agent system without temperature-sensitive gel is used to test the indoor foaming height and foam stability height.

Experimental steps: firstly, preparing a foaming agent system according to the steps of Embodiment 3 (the only difference from Embodiment 3 is that no temperature-sensitive gel is added in the formula of the foaming drainage agent system), and diluting the foaming drainage agent system by 20 times with the gas well backflow liquid without foaming agent measures to obtain foaming agent system solution without temperature-sensitive gel; then carrying out a test group Z and a test group N by using 2151 Roche foam meter.

Specifically, in the test group Z, the indoor foaming height and foam stability height of the foaming drainage agent system solution are tested at 90° C. ; and in the test group N, the indoor foaming height and foam stability height of the foaming drainage agent system solution are tested at 50° C.

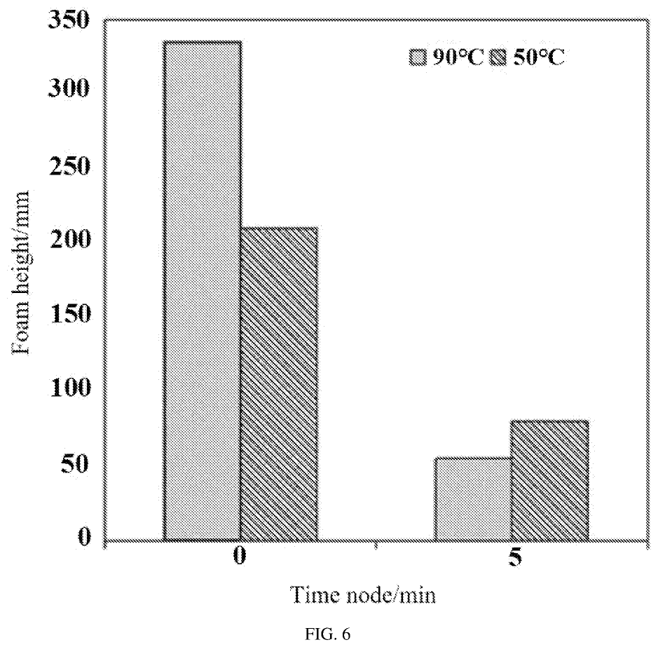

The test results are shown in FIG. 6: at 90° C., the initial height of the foaming drainage agent system solution without temperature-sensitive gel is 355 mm, and the foam height is 55 mm after 5 min; at 50° C., the initial height of the foaming drainage agent system solution without temperature-sensitive gel is 210 mm, and the foam height is 80 mm after 5 min.

Therefore, by comparing FIG. 1 and FIG. 6:
(1) under the condition of 90° C., the foam height in the test group Z decreases rapidly from 0 min to 5 min, and the decreasing speed of the test group Z is obviously faster than the falling speed of the test group X. Therefore, the foam stability of the foaming drainage agent system solution without temperature-sensitive gel is obviously lower than the foam stability of the foaming drainage agent system prepared in Embodiment 3, indicating that the addition of temperature-sensitive gel effectively improves the foam stability of the system at high temperature; and
(2) under the condition of 50° C., the foam falling speed of the test group N is equivalent to the foam falling speed of the test group Y, that is, the foaming drainage agent system solution without temperature-sensitive gel is equivalent to the foaming drainage agent system solution with temperature-sensitive gel at 0 min and at 5 min, indicating that the temperature-sensitive gel is unable of stabilizing foam at low temperature.

### Experimental Example 1

The foaming drainage agent system solution prepared in Embodiment 4 is tested for sterilization according to the standard.

The contents of Sulfate-Reducing Bacteria (SRB), Fe bacteria (FB), saprophytic bacteria (TGB) in the blank sample are 1300/mL, 12000/mL and 6000/mL, respectively. When they are added to the foaming drainage agent system sample prepared in Embodiment 3 at a mass concentration of 0.5%, the content of SRB bacteria decreases to 0/mL, FB bacteria decreases to 13/mL, and TGB bacteria decreases to 20/mL. The results show that the system has good bactericidal performance.

### Experimental Example 2

The foaming drainage agent system solution prepared in Embodiment 4 is tested for indoor viscoelasticity, and a comparison between 50° C. and 90° C. is carried out.

In this experiment, the storage modulus and energy dissipation modulus are tested by high temperature rheometer with shear stress of 0.5MPa and oscillation frequency of 0.1-10Hz.

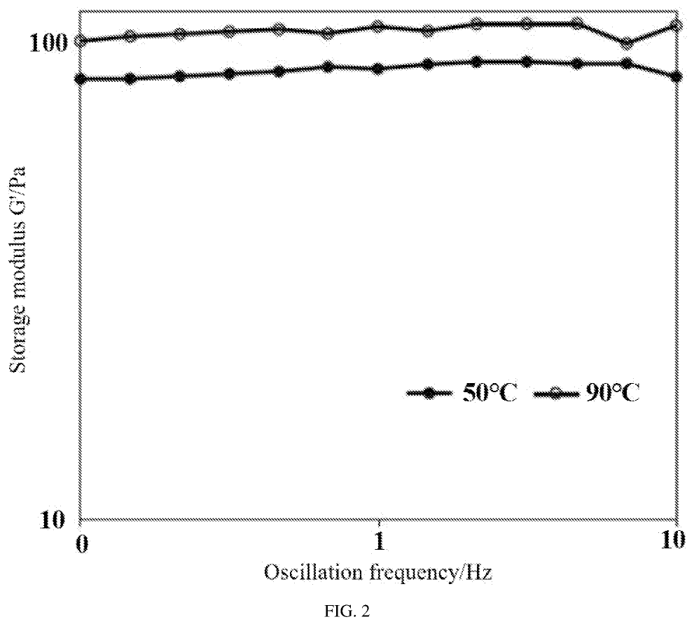

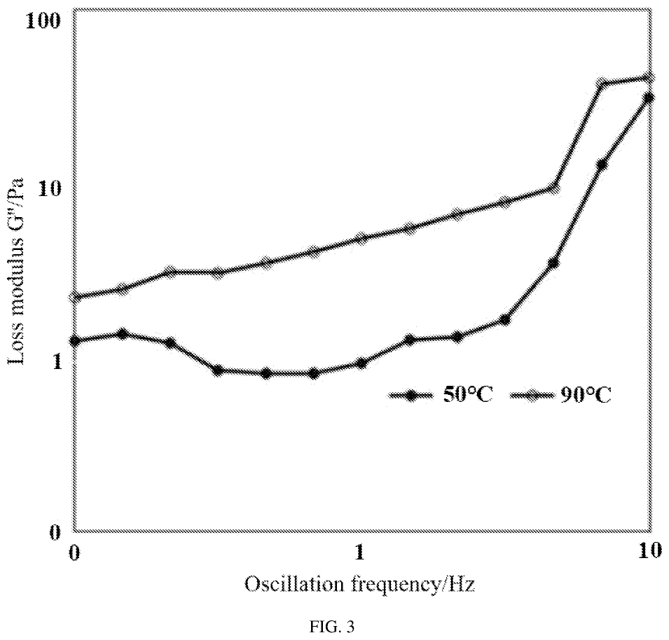

The experimental results are shown in FIG. 2 and FIG. 3. From the comparison of FIG. 2 and FIG. 3, it can be seen that the storage modulus and the energy consumption modulus at 90° C. are both higher than the storage modulus and the energy consumption modulus at 50° C., indicating that the viscoelasticity of the system at 90° C. is stronger than the viscoelasticity of the system at 50° C., and the system is more stable.

### Experimental Example 3

The foaming drainage agent system solution prepared in Embodiment 4 is used for indoor observation experiment of foam coarsening behavior, and a comparison between 50° C. and 90° C. is carried out.

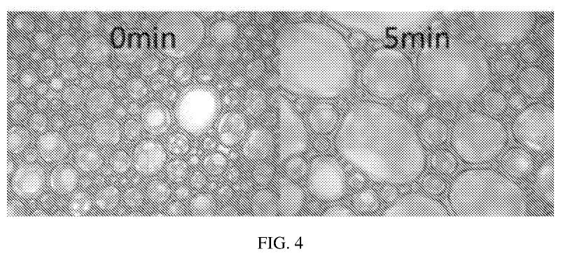

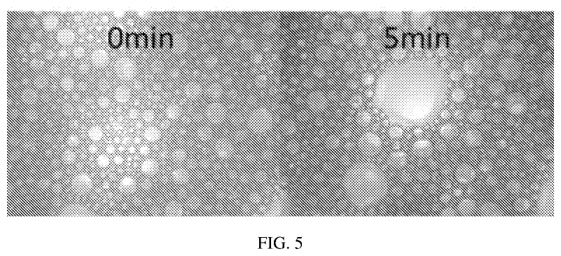

As results shown in FIGS. 4 and 5, the foam at 90° C. is smaller, more uniform and more thermodynamically stable than the foam at 50° C.

The foregoing is only the preferred embodiment of the present disclosure, and it should be understood that the present disclosure is not limited to the form disclosed herein, and should not be regarded as the exclusion of other embodiments, but can be used in various other combinations, modifications and environments, and can be modified through the above teachings or the technology or knowledge in the related fields within the scope of the concepts described herein. However, modifications and changes made by those skilled in the art should be within the scope of protection of the appended claims without departing from the spirit and scope of the disclosure.

What is claimed is:

1. A temperature-sensitive foaming drainage agent system for high-temperature and high-salt gas reservoirs, comprising the following components in parts by mass: 50-75 parts of foaming agent, 1-3 parts of temperature-sensitive material, 2-5 parts of bactericide and 500-800 parts of water,
wherein the temperature-sensitive material is temperature-sensitive gel;
the foaming agent comprises sulfonate anionic surfactant A, sulfonate anionic surfactant B, and an amine oxide zwitterionic surfactant;
and a mass ratio of sulfonate anionic surfactant A, sulfonate anionic surfactant B and amine oxide zwitterionic surfactant is 2:2:1;
the sulfonate anionic surfactant A is sodium dodecyl benzene sulfonate, and the sulfonate anionic surfactant B is sodium α-olefin sulfonate;
the amine oxide zwitterionic surfactant is N,N-dimethyldodecylamine-N-oxide;
the bactericide is hexadecyl trimethyl ammonium chloride;
a preparation of the temperature-sensitive gel comprises following steps:
step 1, firstly weighing 100 parts of cotton fiber by mass, and impregnating cotton fiber with 3500 parts of 40% (mass fraction) sodium hydroxide solution at 30° C. for 1 h;
step 2, squeezing impregnated cotton fiber obtained in the step 1, where a squeezing ratio is 3.0, and then crushing and curing the cotton fiber by a crusher for 4h;
step 3, putting material obtained in the step 2 into a kettle for vacuumizing, then sequentially adding 200 parts of propylene oxide and 900 parts of carbon tetrachloride into the kettle, then heating to 50° C., and keeping the temperature for reaction for 3h;
step 4, reacting material prepared in the step 3 at 80° C. for 2h, then neutralizing, washing, centrifugally dehydrating and drying at 95° C. to prepare a crude product;
step 5, placing the crude product obtained in the step 4 in warm water at 80° C., stirring to dissolve the crude product, and then cooling the crude product to room temperature; and
step 6, heating colloid solution obtained in the step 5 to a colloid dehydration shrinkage temperature; finally, obtaining white powder after centrifugation, drying and crushing, the white powder is the temperature-sensitive gel with a purity of 95% and a gel point of 60-70° C.

2. The temperature-sensitive foaming drainage agent system for high-temperature and high-salt gas reservoirs according to claim 1, wherein water is tap water or clean water from a water source well near the gas well.

3. A preparation method for preparing the temperature-sensitive foaming drainage agent system for high-temperature and high-salt gas reservoirs according to claim 1, comprising following steps:
S1, taking each component according to a formula ratio;
S2, adding the temperature-sensitive material into water and uniformly stirring at normal temperature; and
S3, adding the foaming agent and a bactericide into the solution prepared in the S2, and uniformly stirring to obtain the temperature-sensitive foaming drainage agent system for high-temperature and high-salt gas reservoirs.

4. An application of the temperature-sensitive foaming drainage agent system for high-temperature and high-salt gas reservoirs according to claim 1 in gas well drainage and gas production technology.

5. The application according to claim 4, wherein a dosing concentration of the temperature-sensitive foaming drainage agent system for high-temperature and high-salt gas reservoirs is 5%.
